(19) United States
(12) Patent Application Publication
(10) Pub. No.: US 2005/0126227 A1
(43) Pub. Date: Jun. 16, 2005

(54) Process for determining the drawing tension in the manufacturing of an optical fibre

(76) Inventor: Antonio Collaro, Torre del Greco (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/499,219

(22) PCT Filed: Dec. 19, 2001
(86) PCT No.: PCT/EP01/15089

(51) Int. Cl. C03B 37/07

(52) U.S. Cl. 65/378; 65/413; 65/381; 65/382; 65/485; 65/486; 65/491

(57) ABSTRACT

A process for manufacturing an optical fibre by producing a glass core rod; measuring the refraction index profile in a plurality of sections of the core rod, for obtaining a corresponding plurality of refractive index profiles; processing the plurality of refractive index profiles for determining a drawing tension variation law; depositing glass soot onto the core rod to obtain a glass preform; consolidating the glass preform; and drawing the optical fibre from the glass preform by applying a drawing tension to the optical fibre, wherein drawing tension is varied in accordance to the drawing tension variation law.

The present invention relates to a process and an assembly for manufacturing an optical fibre. In particular, the present invention relates to a process for manufacturing an optical fibre having substantially uniform optical properties along its length and an assembly for manufacturing such a fibre. Moreover, the present invention relates to a method and a device for determining a drawing tension variation law for an optical fibre drawing process.

Optical fibres comprise a core surrounded by cladding material having a refractive index lower that that of the core. Depending on the type of fibre and its desired performance characteristics, the radial distribution of the refractive index in a cross section of the fibre can be simple or complex. Typical examples of refractive index profiles are: that of step-index single-mode fibres, having a substantially uniform refractive index within the core and a sharp decrease at the core-cladding interface; that used to minimize intermodal dispersion in high-bandwidth multimode fibres, having a nearly parabolic radial shape in the core region; and that typically used for dispersion-shifted fibres and known as “segmented-core” profile, having a central triangular portion and a step portion of lower dimension surrounding the central triangle.

As is well known, a process for manufacturing an optical fibre comprises first producing a glass preform of vitreous material, and then drawing the optical fibre from said preform.

The glass preform is usually produced by depositing glass soot on an appropriate cylindrical substrate by means of a burner and by consolidating the resulting glass body. Deposition techniques such as MCVD (Modified Chemical Vapor Deposition), OVD (Outside Vapor Deposition) and VAD (Vapor-phase Axial Deposition) are typically used.

Patent EP 367871 in the name of Corning Glass Works describes a method for obtaining an optical fibre by an OVD process. This method initially comprises the step of depositing particles of glass comprising base glass and a refractive-index-increasing dopant (such as Ge) onto a mandrel (defining a deposition support). The mandrel is then removed and the resulting soot preform is consolidated so as to form a core preform. The core preform is stretched and the hole in it is closed to form a core rod, or cane. Cladding glass soot is then deposited on the core rod (overcladding process) to obtain a final preform, which is then consolidated and drawn so as to obtain an optical fibre.

The preform consolidation process can be performed, for example, as described in U.S. Pat. No. 5,641,333, by placing the porous preform in a consolidation furnace where it is dried and sintered. In the consolidation process for obtaining the core preform, a first drying gas mixture, which usually contains helium and a drying agent such as chlorine, may flow into the hole of the preform (during the drying step or during the entire consolidation process). A drying agent can also be flowed through the furnace (see, for example, U.S. Pat. No. 4,165,223). The drying step reduces the residual OH content of the preform, thereby reducing, in the resultant optical fibre, the absorption loss caused by OH. The step of sintering produces a dense, substantially clear glass preform, to be used for the overcladding step or for drawing into an optical fibre. The entire porous preform can be dried before the sinter step begins; alternatively, the preform can be subjected to a gradient consolidation process whereby the temperature of each individual portion of the preform increases and decreases with the approach and passing of the hot zone of the furnace, respectively. As the hot zone approaches, the preform portion becomes sufficiently hot that the drying gas mixture can react with the OH ions in the glass, but the preform temperature is not so high that preform porosity is decreased to the point that drying gas flow is impeded. As the preform portion is subjected to the maximum temperature region of the hot zone, the pore size decreases and the preform element then completely sinters and clarifies.

Still according to U.S. Pat. No. 5,641,333, during the consolidation process, dopant from the core portion of a porous preform can migrate through the pores to the cladding portion, thereby creating a dopant depleted region at the edge of the core and a corresponding dopant rich region in the adjacent cladding; this combination is known as a “diffusion tail”.

The Applicant has noted that in the consolidation process as previously described, due to the progressive insertion of the preform into the hot zone of the furnace, the different longitudinal sections of the preform are subjected to a slightly different temperature treating, which causes a different migration of the dopant towards the region of lesser concentration. Therefore, a different refraction index profile can result in the different longitudinal portions of the preform.

The Applicant has also verified that another possible cause of variation of the refractive index profile along the fibre is represented by dynamic fluctuations during the core preform stretching process. In fact, the Applicant has noted that during this process, which can be performed for example as described in EP367871, i.e. by using a draw furnace to heat the preform and a motor-driven tractor to pull a glass rod from the heated preform, dynamic variations of the stretching velocity and of temperature can cause variations of the diameter of the glass rod, and the refractive index profile can therefore vary along the glass rod.

The final drawing process is typically performed in appropriate drawing towers, wherein the final preform is supplied, along a vertical direction, to a furnace, so as to obtain melting of a lower portion thereof. The molten material is then drawn and cooled so as to obtain an optical fibre with the desired characteristics. These characteristics are obtained by suitably setting the parameters of the drawing process, including the furnace temperature and the fibre drawing speed.

Usually, the drawing process is carried out for its entire duration under the same process conditions, i.e. without variations in the process parameters. In particular, the fibre is typically drawn with a constant tension. The importance of maintaining a constant tension during drawing for having uniform optical characteristics in the fibre is explained, for example, in U.S. Pat. No. 5,079,433, relating to a method for monitoring fibre tension during drawing, and in U.S. Pat. No. 5,961,681, which teaches to make the tension substantially constant during drawing by decreasing the temperature within the furnace with time.

Known exceptions from drawing at a constant tension are provided for example by U.S. Pat. No. 5,851,259, wherein tension applied to the fibre during draw is modulated (according to a half-sinusoidal, triangular or trapezoidal waveform) for suppressing Brillouin scattering loss in a Ge-doped optical fibre, and by U.S. 2001/0003911, wherein the amount of heat applied to the lower end of the optical preform is varied to adjust the draw tension and thereby change the local chromatic dispersion along the optical fibre, thus obtaining a dispersion-altered optical fibre.

As previously stated, the Applicant has identified two different possible causes of variations in the refractive index profile along the optical fibre: a non-uniform heat treatment during consolidation and dynamic fluctuations during stretching. A fibre having longitudinal variations of the refractive index profile will have corresponding variations of its optical propagation parameters (such as the mode dispersion, the mode field diameter and the cut-off wavelength). Apart from particular cases, these variations are undesired.

Accordingly, the Applicant has tackled the problem of producing an optical fibre wherein the optical propagation parameters are substantially uniform along the fibre, in spite of said undesired effects during consolidation and stretching.

The Applicant has found that, by measuring the refractive index profile in different longitudinal portions of the core rod or of the final preform, and using the results of this measurement to control the fibre tension during the drawing process, it is possible to obtain an optical fibre having substantially uniform optical propagation parameters. In particular, by performing a numeric simulation wherein, starting from the measured refractive index profile along the core rod or the final preform, the effect of varying the drawing tension on predetermined propagation parameters is determined, a variation law for the tension to be applied during the drawing process in order to minimize variations of the propagation optical parameters along the fibre can be established.

The Applicant has also found that, to obtain the said uniformity of optical properties, it is advantageous to rely on the measurement of the refractive index profile on the core rod for intervening, besides on the drawing tension, also on the amount of overcladding to be deposited around said core rod (i.e. the mass of soot applied onto the core rod in the overcladding process), since also this parameter may influence the relation between the drawing tension and the refractive index profile.

According to a first aspect thereof, the present invention relates to a method for determining a drawing tension variation law for an optical fibre drawing process, comprising the steps of:
measuring the refraction index profile in a plurality of sections of a glass preform suitable to be drawn into the optical fibre, or of a core rod suitable to define a central portion of the optical fibre, for obtaining a corresponding plurality of refractive index profiles; and
processing the said plurality of refractive index profiles for determining the drawing tension variation law.

Processing the plurality of refractive index profiles preferably comprises simulating the effect of varying the drawing tension on each refractive index profile of the plurality of refractive index profiles.

Processing the plurality of refractive index profiles may comprise determining a target function that correlates at least a predetermined optical propagation parameter with the drawing tension and with a normalized longitudinal coordinate along the glass preform or the core rod, respectively, and finding a path in the plane of the values of the drawing tension and of the normalized longitudinal coordinate that optimizes the target function.

According to a second aspect, the present invention relates to a process for manufacturing an optical fibre, comprising the steps of:
producing a glass preform;
measuring the refraction index profile in a plurality of sections of the glass preform for obtaining a corresponding plurality of refractive index profiles;
processing the plurality of refractive index profiles for determining a drawing tension variation law; and
drawing the optical fibre from the glass preform by applying a drawing tension to the optical fibre, comprising varying the drawing tension in accordance to the drawing tension variation law.

Alternatively, the process for manufacturing an optical fibre comprises the steps of:
producing a glass core rod;
measuring the refraction index profile in a plurality of sections of the core rod, for obtaining a corresponding plurality of refractive index profiles;
processing the plurality of refractive index profiles for determining a drawing tension variation law;
depositing glass soot onto the core rod to obtain a glass preform;
consolidating the glass preform; and
drawing the optical fibre from the glass preform by applying a drawing tension to the optical fibre, comprising varying the drawing tension in accordance to the drawing tension variation law.

Preferably, the step of processing comprises simulating the effect of varying the drawing tension on each refractive index profile of the plurality of refractive index profiles.

The step of processing may comprise determining a target function that correlates at least a predetermined optical propagation parameter with the drawing tension and with a normalized longitudinal coordinate along the glass preform or the core rod, respectively, and finding a path in the plane of the values of the drawing tension and of the normalized longitudinal coordinate that optimizes the target function.

The step of processing may also comprise determining the amount of the glass soot to be deposited onto the cylindrical glass body, for example by simulating, for each of said sections, the effect of varying the amount of the deposited glass soot on each refractive index profile of the plurality of refractive index profiles.

Varying the drawing tension may comprise varying the speed at which the fibre is drawn. Alternatively, since drawing the optical fibre comprises subjecting the glass preform to a glass melting temperature, varying the drawing tension may comprise varying the glass melting temperature.

According to a further aspect, the present invention relates to a device for determining a drawing tension variation law for an optical fibre drawing process, comprising a device for measuring the refractive index profile along a cylindrical glass body suitable to be formed into at least a central portion of the optical fibre and a processing unit for processing the results of the measurement to obtain the draw tension variation law. A cylindrical glass body suitable to be formed into at least a central portion of the optical fibre may be a core rod or a final glass preform. The latter is suitable to be formed into the entire optical fibre.

The processing unit preferably comprises means for simulating the effect of varying the draw tension on the measured refractive index profile.

The present invention also relates to an assembly for manufacturing an optical fibre, comprising:
an apparatus for producing a cylindrical glass body suitable to be formed into at least a central portion of the optical fibre;
a device for determining a drawing tension variation law as previously defined; and
a drawing apparatus for drawing the optical fibre, including draw tension regulating means to regulate the draw tension according to the draw tension variation law.

The assembly may further comprise a deposition device for depositing glass soot onto the cylindrical glass body so as to obtain a glass preform and a consolidation device for consolidating the glass preform.

The draw tension regulating means may comprise a glass melting furnace and a control unit for feeding to the furnace a control signal in accordance with said draw tension variation law.

Alternatively, the draw tension regulating means may comprise a traction device for pulling the optical fibre from the glass preform and a control unit for feeding to the traction device a control signal in accordance with the draw tension variation law.

The processing unit may also comprise means for simulating the effect of varying the amount of the deposited glass soot on the measured refractive index profile.

Further details may be obtained from the following description, which refers to the accompanying drawings listed below:

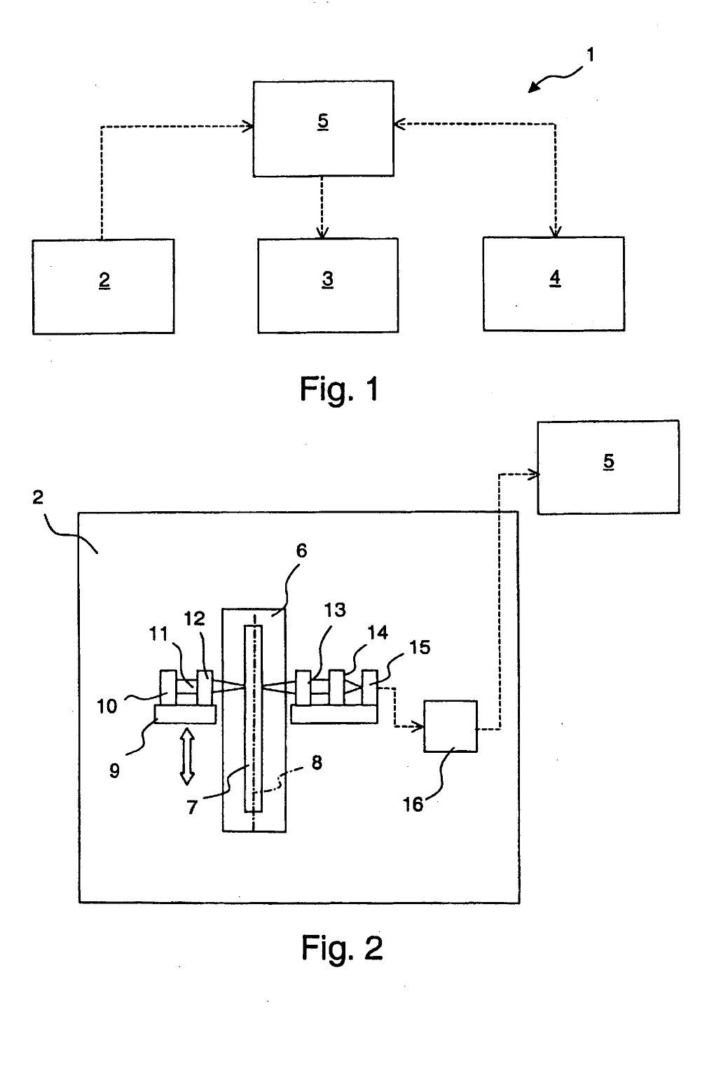

FIG. 1 is a block representation of an assembly according to the present invention;

FIG. 2 shows schematically a refractive index measuring device, which is part of the assembly of FIG. 1;

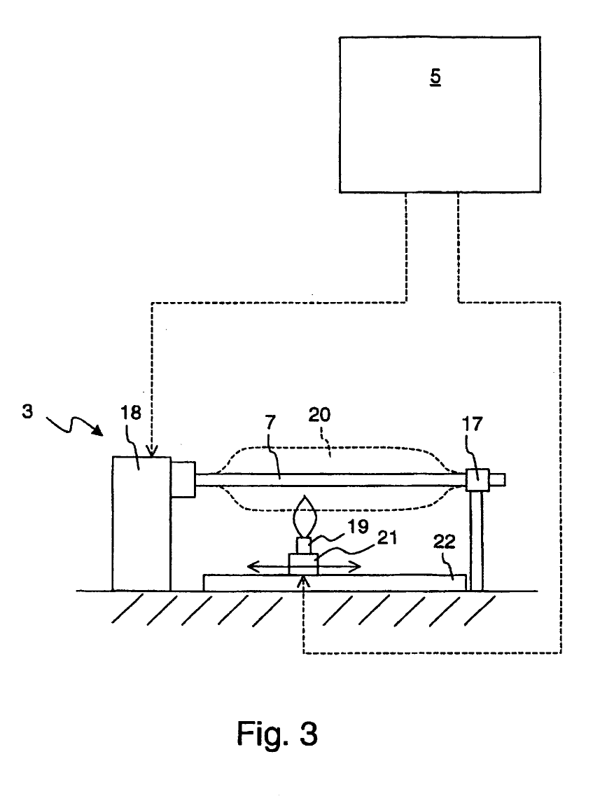

FIG. 3 is a schematic representation of a vapour deposition device, which is part of the assembly of FIG. 1;

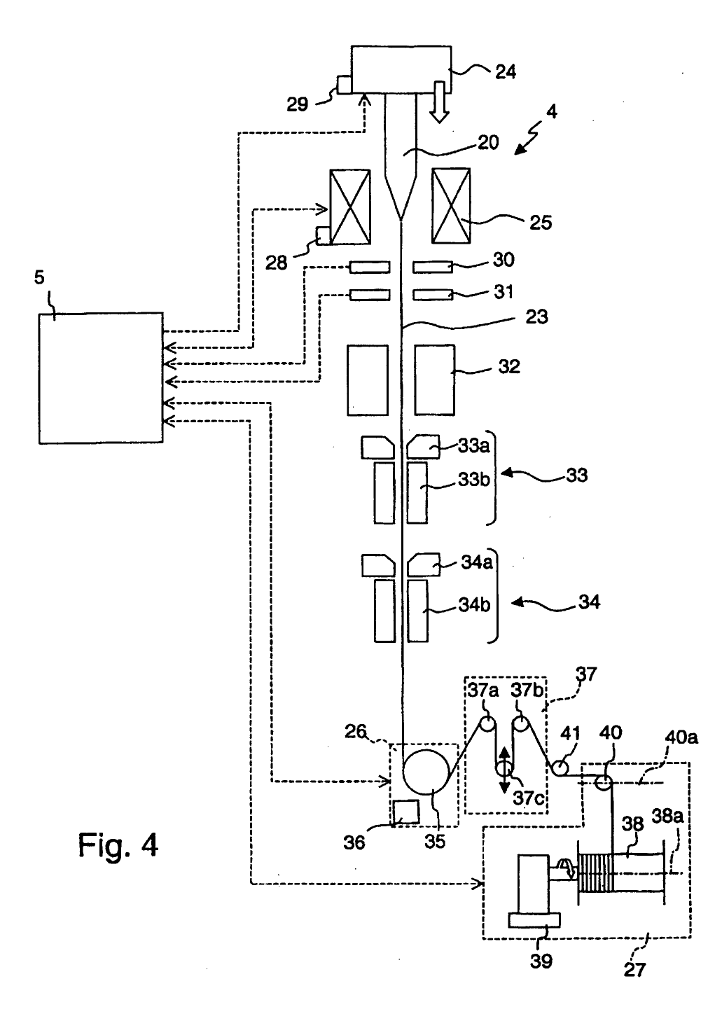

FIG. 4 illustrates schematically a drawing tower that is part of the assembly of FIG. 1;

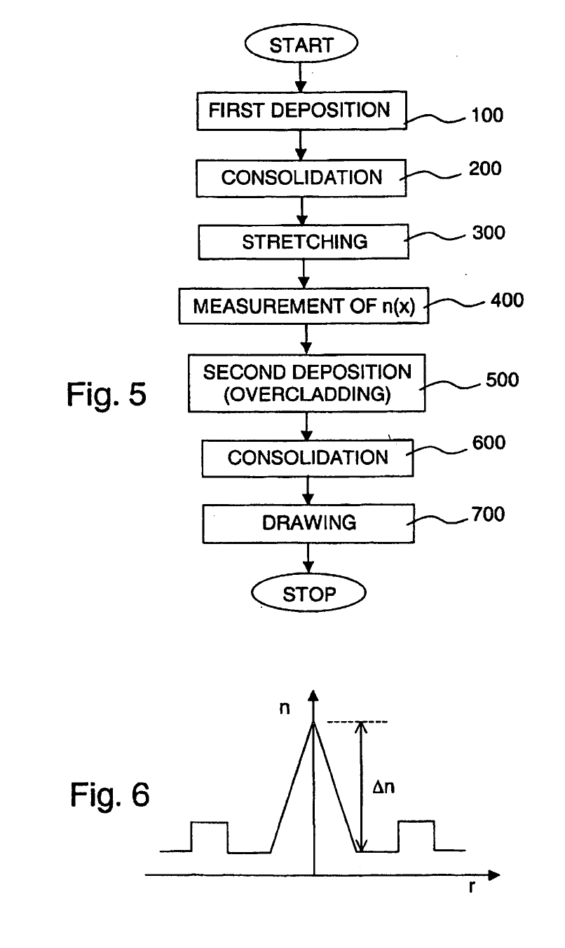

FIG. 5 is a flow-chart showing the different steps of a process for manufacturing an optical fibre according to the present invention;

FIG. 6 is a possible refractive index profile obtainable by a vapour deposition process;

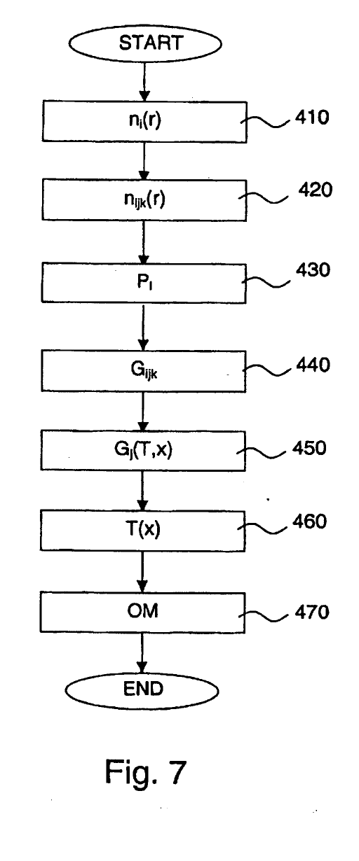

FIG. 7 is a flow-chart showing the sub-steps of one of the steps of FIG. 5;

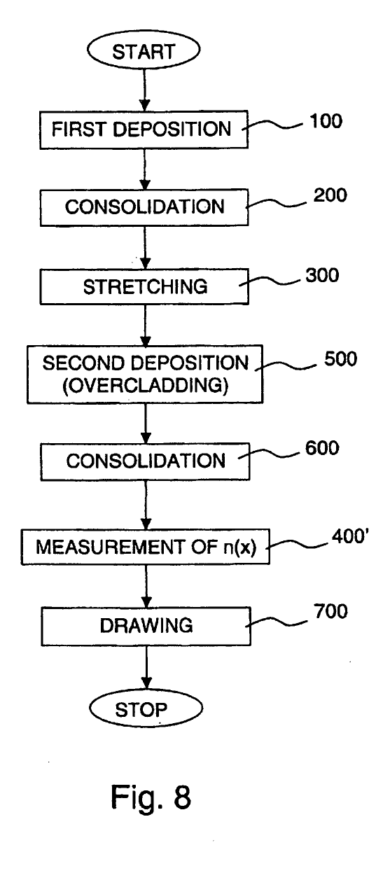

FIG. 8 relates to the steps of an alternative process to that of FIG. 5;

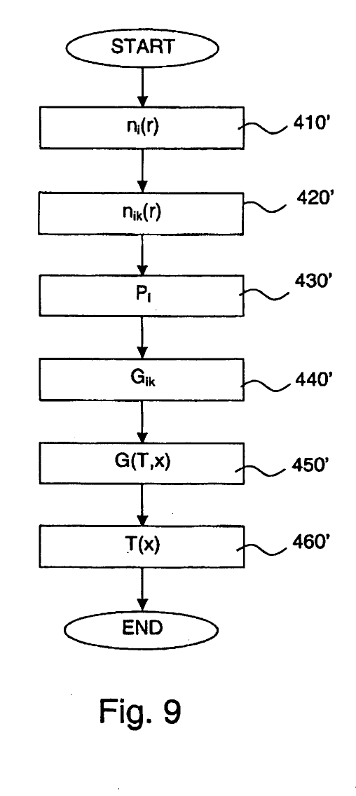

FIG. 9 illustrates the sub-steps of one of the steps of FIG. 5; and

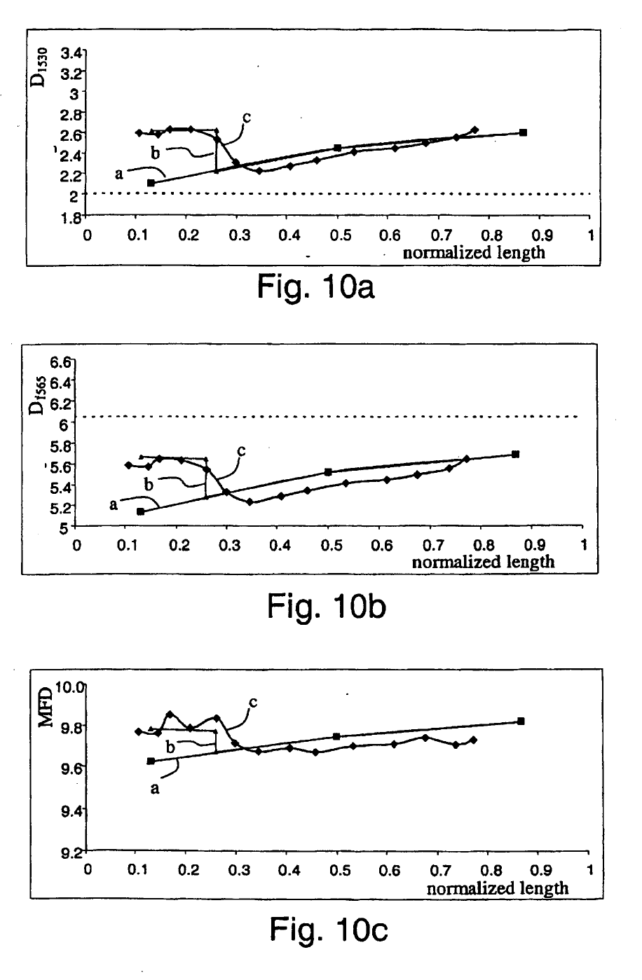

FIGS. 10a, 10b and 10c represent the results of a simulation and an experiment.

FIG. 1 schematically shows, by respective blocks, the main components of an assembly 1 for producing, according to the present invention, an optical fibre having substantially uniform optical characteristics.

Assembly 1 comprises:
a measuring device 2 apt to measure the refractive index profile of a cylindrical glass body, such as a core rod and a glass preform, and to process the results of the measurement so as to obtain process control information;
a vapour deposition device 3 for depositing glass soot on a cylindrical substrate such as a core rod; and
a drawing tower 4 for drawing an optical fibre from a final preform; and
a central control unit 5 electrically connected to the measuring device 2 to receive the process control information and to the vapour deposition device 3 and the drawing tower 4 to control the operation thereof according to said process control information.

Said process control information comprise a law T(z) of variation of the drawing tension T to be applied to the longitudinal portion of coordinate z of the final preform during the drawing process, and preferably also an optimum value of the overcladding mass OM to be deposited on the core rod during the overcladding deposition process. As will be clarified in the following, the measure of the refractive index and the control of the drawing process are essential aspects of the present invention, while the control of the overcladding mass in the overcladding deposition process is only a preferred aspect.

Measuring device 2 may be for example of the type described in U.S. Pat. No. 4,227,806 or in U.S. Pat. No. 4,726,677, which are incorporated by reference herein. Moreover, an instrument for measuring the refractive index profile of a core rod or of a preform is made available by NETTEST, Copenhagen, Denmark (Preform Analyzer 2600).

According to U.S. Pat. No. 4,227,806, in order to measure the refractive index profile of a glass preform, a laser beam scans the preform and the deflection angle thereof is measured as the beam exits the preform. The deflection angle is plotted versus the incident beam position and that plot is integrated to provide a curve that is compared to theoretically developed plots having known parameters to determine parameters of the fiber preform. As described in U.S. Pat. No. 4,726,677, the index profiles may also be directly computed from the measured deflection angles. If θ(x) is the angle of refraction observed for a beam incident on the preform a distance x from the preform axis, then the radius of closest approach to the preform axis r(x) of that beam is given by

$$r ( x ) = x \cdot exp ( - \frac{1}{π} \cdot {\int }_{x}^{R} \frac{θ ( t ) ⅆ t}{\sqrt{{t}^{2} - {x}^{2}}} )$$

where R is the preform radius and t is the variable of integration. The refractive index n[r(x)] at radius r(x) is given by

$$n ( r ) = n ( R ) \cdot exp ( \frac{1}{π} \cdot {\int }_{x}^{R} \frac{θ ( t ) ⅆ t}{\sqrt{{t}^{2} - {x}^{2}}} )$$

where n(R) is the refractive index of the preform at its surface. Using these equations to establish the refractive index profile of an optical fibre preform is preferable to using earlier approach of U.S. Pat. No. 4,227,806, since these equations are applicable to a much larger class of index profiles.

With reference to FIG. 2, device 2 may comprise a glass chamber 6 apt to host a core rod 7 coaxial to an axis 8 and a platform 9 movable parallel to axis 8. Chamber 6 is preferably filled with an index-matching liquid (for example an oil) having substantially the same refractive index of core rod 7.

Device 2 further comprises the following components, mounted on the platform 9:
a laser 10 for generating a collimated laser beam 11;
a first lens 12 to focus the laser beam 11 onto core rod 7;
a second lens 13 to receive the laser beam 11 from the opposite side of core rod 7 and collimate it again;
a cylindrical lens 14 to compress the beam 11 in one dimension; and
a position-sensing detector 15 to detect position of the beam 11.

A mirror (not shown) may also be provided to direct beam 11 from laser 10 to first lens 12. This mirror may be a rotatable mirror controlled by a galvanometer, for scanning the beam on the section of core rod 7.

Detector 15 and lens 14 are spaced apart of a distance corresponding to the focal length f₂ of second lens 13. Hence, if a beam originally incident a distance x from axis 8 impacts on the detector (after being refracted) a distance d(x) offset from the centre of the detector, the angle of deflection θ(x) is given as

$$θ ( x ) = {tan}^{- 1} ( \frac{d ( x )}{{f}_{2}} ) .$$

For maximizing the spatial resolution, focusing of the system before data taking may be performed, for example in the way taught in U.S. Pat. No. 4,726,677.

Detector 15 has an associated electronics (not shown) that provides an electric output indicative of the position of beam 11. Device 2 also comprises a processing unit 16, which is apt to receive said electronic output and to provide the refractive index profile of the considered core rod section. After the measurement has been performed on a predetermined number of spaced sections of the glass body, processing unit 16 is also apt to process the measurement data to obtain an optimum value of the overcladding mass OM to be applied over the core rod 7 in the overcladding deposition process and an optimum variation law T(z) for the tension to be applied to the fibre in the drawing process. In particular, this processing provides a value of OM and a law T(z) such that an optical fibre having substantially uniform optical propagation characteristics can be obtained. The processing operations performed by unit 16 will be described in detail in the following.

Unit 16 is electrically connected to the central control unit 5, for feeding to unit 5 a signal indicative of said law T(z) and overcladding mass OM.

With reference to FIG. 3, vapour deposition device 3 comprises a support member 17 for supporting one end of the core rod 7, a motor 18 for holding the opposite end of the core rod 7 and for setting the core rod 7 into rotation about its axis, and a burner 19 for depositing glass soot on the core rod 7 so as to form a final preform 20 (represented by a dashed line during its formation). Burner 19 is fixed onto a motorized slide 21, which is in turn mounted on a guide 22 that permits movement of slide 21 parallel to core rod 7. Therefore, burner 19 can be translated in a controlled way in that direction.

Device 3 also comprises a gas delivery system not shown, for feeding to burner 19 the gas required for generating the glass soot.

Device 3 is electrically connected to control unit 5 to receive control signals for slide 21 and motor 18. In practice, control unit 5 provides control signals for starting the deposition process and then for stopping it when an overcladding mass corresponding to OM has been deposited. The same control unit may be used to control the gas delivery system so as to start gas feeding to burner 19 when the process begins and to stop it when the process is over.

With reference to FIG. 4, drawing tower 4 comprises a plurality of components that are substantially aligned in a vertical drawing direction (whence the term “tower”). The choice of a vertical direction in order to perform the main steps of the drawing process arises from the need to exploit the gravitational force so as to obtain, from the final glass preform 20, molten material from which a fibre 23 can be drawn.

In detail, the tower 4 comprises a device 24 for supporting and supplying the preform 20, a furnace 25 for performing a controlled melting of a lower portion of the preform 20, a traction device 26 for pulling the fibre 23 from the preform 20 and a device 27 for winding the fibre 23.

The furnace 25 may be of any type designed to produce the controlled melting of a preform. Examples of furnaces that can be used in the tower 4 are described in U.S. Pat. No. 4,969,941 and U.S. Pat. No. 5,114,338. The furnace 25 may be provided with a temperature sensor 28 designed to generate a signal indicative of the temperature inside the furnace 25. The furnace temperature is a process parameter that may be varied during the drawing process in order to vary the drawing tension.

Moreover, support device 24 preferably comprises a preform position sensor 29, providing a signal indicative of the normalized longitudinal coordinate z of the portion of the preform 20 that is melting in that instant.

Preferably, at the outlet of the furnace 25 there is a tension-monitoring device 30, designed to generate a signal indicating the tension of the fibre 23. The monitoring device 30 may be, for example, of the type described in U.S. Pat. No. 5,316,562 or of the type described in U.S. Pat. No. 5,079,433. Device 30 may be also positioned differently along tower 4, in particular in any position between furnace 25 and traction device 26.

Drawing tower 4 may further comprise a diameter sensor 31, positioned underneath device 30 in the particular embodiment here described, which is designed to generate a signal indicating the diameter of the fibre 23 without any coatings. Preferably, the diameter sensor 31 also performs the function of a surface defect detector, detecting defects in the glass of the fibre 23, such as bubbles or inclusions. The diameter sensor 31 may be, for example, of the interferometric type. An instrument suitable for this scope is model LIS-G manufactured by CERSA, Park Expobat 53, Plan de Campagne, F13825, Cabriès, Cedex, France. This type of sensor is designed, in particular, to generate a first signal proportional to the difference between the detected diameter value and a predefined diameter value, and a second signal indicating the presence of any surface defects.

A cooling device 32 may be situated underneath the furnace 25 and the diameter sensor 31 and may, for example, be of a type having a cooling cavity designed to be passed through by a flow of cooling gas. The cooling device 32 is arranged coaxially with respect to the drawing direction, so that the fibre 23 leaving the furnace 25 can pass it through. The cooling device 32 may be, for example, of the type described in U.S. Pat. No. 5,314,515 or the type described in U.S. Pat. No. 4,514,205. The cooling device 32 may be provided with a temperature sensor (not shown) designed to provide an indication of the temperature in the cooling cavity. Since the speeds at which an optical fibre is drawn are usually relatively high, the cooling device 32 must allow rapid cooling of the fibre 23 to a temperature suitable for the successive processing steps and, in particular, suitable for the surface coating described below.

Preferably, tower 4 further comprises a first and a second coating device 33, 34, positioned underneath the cooling device 32 in the vertical drawing direction and designed to deposit onto the fibre 23, as it passes through, a first protective coating and, respectively, a second protective coating overlapping the first one. Each coating device 33, 34 comprises, in particular, a respective application unit 33a, 34a which is designed to apply onto fibre 23 a predefined quantity of resin, and a respective curing unit 33b, 34b, for example a UV-lamp oven, for curing the resin, thus providing a stable coating. The coating devices 33, 34 may be, for example, of the type described in U.S. Pat. No. 5,366,527 and may be more or less than two, depending on the number of protective coatings that are to be formed on the fibre 23.

The traction device 26 is positioned underneath coating devices 33, 34 and is preferably of the single pulley or double pulley type. In the illustrated embodiment, the traction device 26 comprises a single motor-driven pulley 35 that is designed to draw the fibre 23 in the vertical drawing direction. The traction device 26 may be provided with an angular velocity sensor 36 that is designed to generate a signal indicating the angular velocity of the pulley 35 during its operation. The speed of rotation of the pulley 35 and, therefore, the drawing speed of the fibre 23 during the drawing process, are process parameters that may be varied during the drawing process in order to produce a variation in the drawing tension of the fibre 23.

In the case where, during the drawing process, undesired variations in the diameter of the fibre 23 occur, the signal of the diameter sensor 31 may be used to vary automatically the drawing speed of the fibre 23 so as to have again the predefined diameter value. In practice, if the diameter is reduced to below a predefined threshold, the drawing speed is decreased by an amount proportional to the reduction in diameter, while if the diameter is increased above a further predefined threshold, the drawing speed is increased by an amount proportional to the increase in diameter. Examples of the use of diameter sensor signals and surface defect sensors are provided by U.S. Pat. No. 5,551,967, U.S. Pat. No. 5,449,393 and U.S. Pat. No. 5,073,179. The number and the arrangement of the diameter sensors and surface defect sensors may be different from those indicated.

Tower 4 may also comprise a device 37 for adjusting the tension of the fibre 23 downstream the traction device 26. Device 37 is designed to counterbalance any variations in tension of the fibre 23 between pulley 35 and winding device 27. The device 37 comprises, preferably, a first and a second pulley 37a, 37b that are mounted idle and in a fixed position, and a third pulley 37c which is free to move vertically, under the action of its own weight and the tension of the fibre 23. In practice, pulley 37c is raised if there is an undesirable increase in the tension of the fibre 23 and is lowered if there is an undesirable decrease in the tension of the fibre 23, so as to keep the said tension constant. The pulley 37c may be provided with a vertical position sensor (not shown) that is designed to generate a signal indicating the vertical position of the pulley 37c and therefore indicating the tension of the fibre 23.

Winding device 27 comprises a reel 38 and a motorized device 39 for supporting and moving the reel 38. The reel 38 has an axis 38a and defines a cylindrical support surface for the fibre 23. Device 39 is designed to support the reel 38 and to set it into rotation about axis 38a.

Winding device 27 also comprises a fibre-feeding pulley 40, which may be mounted on a motorized slide (not shown) movable along an axis 40a parallel to the reel axis 38a, and which is designed to receive the fibre 23 from the tension-adjusting device 37 and to supply the fibre 23 to the reel 38 in a direction substantially perpendicular to the axis 38a. During the process of winding of fibre 23, the controlled movement of pulley 40 allows helical winding of fibre 23 to be performed.

As a possible alternative, pulley 40 may be mounted on a fixed support and reel 38 may be movable in a controlled way along axis 38a.

A further pulley 41 may be present in order to guide the fibre 23 from the tension-adjusting device 37 towards the pulley 40a. Any other pulleys (or guiding elements of another type) may be used, as required.

Control unit 5 is electrically connected to all the sensors and the detectors present along the tower 4 and to all the components of tower 4 whose operation may be controlled from the outside. Control unit 5 is designed to control the various steps of the drawing process on the basis of the values of pre-set process parameter, of the results of the refractive index measurement previously described and on the basis of the signals generated by the sensors and by the detectors positioned along the tower 4. Exchange of information between unit 6 and the various parts of the tower 4 to which it is connected takes place by means of electronic interfaces (not shown) able to convert the digital signals generated by the said unit 6 into analogue signals (for example electrical voltages) suitable for operating the individual parts, and also to convert the analogue signals received from the sensors and the detectors into digital signals designed to be interpreted by said unit 5.

In particular, the following Interfaces may be provided: a first interface associated to furnace 25, allowing unit 5 both to send a control signal to the furnace 25 so as to control its temperature, and to receive information from the temperature sensor 28; a second interface associated to traction device 26 so as to control the angular velocity of pulley 35, and to receive information from the angular velocity sensor 36 associated with said drawing device 26; and a third interface associated to winding device 27, allowing unit 5 both to send a control signal to motorized device 39, so as to control the speed of rotation and of translation of reel 38, and to receive signals from the angular and linear velocity sensors (not shown) associated with the winding device 27.

A process for making a glass preform for optical fibre drawing Is herein below described, with reference to the flow-chart of FIG. 5. The process comprises the following stages.

In a first stage (block 100), a plurality of chemical substances is deposited on a cylindrical mandrel (not shown), for example made of alumina or other ceramic material, by means of a deposition device (not shown). In particular, device 3 or any other vapour deposition device known in the art can be used in this stage. Said substances typically comprise silicium and germanium, deposited as oxides (SiO₂ and GeO₂), which will subsequently form the core and an inner portion of the cladding of the optical fibre.

During the deposition process, the mandrel is set into rotation about its axis and a burner is reciprocated in parallel to the axis of the mandrel for a predetermined number of times and within a predetermined motion range, so as to grow a soot body of predetermined diameter and length.

During the soot deposition, the reactants flow may be varied so as to obtain a predetermined refraction index profile by a controlled deposition of the chemical substances. For example, a refractive index profile such as the one depicted in FIG. 6 may be generated (n being the refractive index and r the radius), which is typical of dispersion-shifted fibres, having in the middle a triangular portion (with the apex in the centre) of height Δn and step-like portions on the sides.

The product of this first stage is a cylindrical preform of glass material, named “core preform”, which will be formed into the core and an internal cladding region of the optical fibre.

In a second stage (block 200), after having extracted the mandrel from the core preform, leaving a central hole therein, the core preform is subjected to a process of drying and consolidation in a furnace of a known type (not shown), which comprises feeding Cl₂ and other gas into the central hole in order to eliminate the hydroxide ions (—OH) and the atoms of water contained in the preform. Thus a vitrified core preform is obtained, wherein the central hole has a lower diameter than in the initial core preform.

The Applicant has verified that, during the process of consolidation, the different longitudinal portions of the core preform may be subjected to different thermal history and to different gas exposure. Such non-uniform temperature treatment can result in a refractive index profile that varies along the preform.

In a third stage (block 300), after vacuum has been created inside the central hole (as described, for example, in U.S. Pat. No. 4,810,276), the vitrified core preform is placed in a vertical furnace of a known type (not shown) for melting a lower end thereof. The fused glass material is stretched downwards by a traction device forming a cylindrical elongated member of predetermined diameter. In this step, the surface tension causes the walls of the hole to collapse. For example, a traction device of the type described in the patent application WO01/49616 can be used, so that a twist is imparted to the elongated member during stretching, thus producing a rod-like member with a high degree of straightness (i.e. without intrinsic shape defects).

The Applicant has verified that, during the core preform stretching process, dynamic fluctuations of the stretching velocity can cause variations of the diameter of the glass rod, which can affect the uniformity of the refractive index profile along the glass body.

After further cooling, the elongated member so produced is cut to obtain a plurality of rods, named “core rods”, having a typical length of about one metre and a typical external diameter of about 10-20 mm.

In a fourth stage (block 400), each core rod is subjected to a measurement of the refraction index profile in a plurality of section thereof, by using the measuring device 2 previously described. Device 2 then processes these data and, as a result of this stage, it feeds to control unit 5 a signal carrying codified the optimum law T(z) for the drawing tension to be applied in the drawing process and the optimum overcladding mass OM to be deposited on the core rod in the overcladding process herein below described.

In a fifth stage (block 500), each core rod is used as a substrate for a further process of vapour deposition (“overcladding”) similar to the one of the first stage and performed by means of deposition device 3. This deposition process comprises depositing on the core rod a plurality of chemical substances (typically including SiO₂), which will subsequently form an external portion of the cladding of the optical fibre. The product of this stage is a low-density cylindrical preform, hereinafter called “final preform”. Control unit 5 is able to determined, by knowing the rotation velocity of motor 18, the translation velocity of slide 21 and the flows of glass precursors fed to burner 19, the time at which an overcladding mass equal to OM has been deposited on the core rod 7. When this time has been reached, control unit 5 stops the deposition process.

In a sixth stage (block 600), the final preform is dried and consolidated by substantially the same procedures as those specified for the third stage, so as to obtain a vitrified final preform.

In a seventh (and last) stage (block 700), the final preform is drawn to obtain an optical fibre. In detail, preform 20 is supported vertically by device 24 and supplied thereby into the furnace 25 for causing a controlled melting of a lower portion thereof. The fibre 23 formed from the melting material is pulled downward by traction device 26 and wound onto reel 38 by winding device 27. Control unit 6 can regulate the preform supplying speed and fibre winding speed during the process, in particular to fit with new values of the drawing speed. During the process, the ratio between the preform supplying speed and the drawing speed shall correspond, in the average, to the squared ratio between the fibre diameter and the preform diameter.

According to the invention, drawing is performed with the tension law T(z) determined in the fourth stage. To vary tension T according to law T(z), control unit 5 may alternatively intervene on the traction device 26 for varying the drawing speed, or on the furnace 25 to vary the temperature therein. The combination of control unit 5 and traction device 26 in one case, and control unit 5 and furnace 25 in the other case, defines therefore draw tension regulating means. Sensor 28 associated to furnace 25 and sensor 36 associated to traction device 26 provide feedback signals to control unit 5 that allow precisely controlling the temperature within the furnace 25 and drawing speed, respectively.

Moreover, during the process the tension-monitoring device 30 furnishes to control unit 5 a feed-back signal indicative of the tension on the fibre 23, which can be used by control unit 5 to vary in the right direction the chosen tension-regulating parameter; i.e. the drawing speed or the furnace temperature. In particular, control units associates the detected tension with a normalized longitudinal coordinate z provided by position sensor 29 (apart from a correction factor, the normalized coordinate z provided by sensor 29 corresponds to the normalized coordinate of the portion of fibre passing through device 30), compares this value with the value corresponding to coordinate z in the target T(z) law previously computed by measuring device 2, and varies the tension-regulating parameter so that the difference between said two values is reduced.

As the fibre is drawn, cooling device 32 cools the fibre 23 and first and a second coating device 33, 34, apply onto the fibre 23 the first and second protective coatings. Moreover, diameter sensor 31 provides its detection signal to control unit 5 and control unit 5 may use this signal to intervene on the traction device 26 for slightly varying the drawing speed.

The stage of measuring the refractive index profile (stage four) is herein below described in better detail with reference to the flowchart of FIG. 7.

This stage starts with the measurement (block 410) of the refraction index profile n(r) on a plurality m of sections S_{I} (i=1, 2, . . . m) of core rod 7, preferably equally spaced, thus obtaining a plurality m of curves n_{I}(r). The measurement is performed according to the teachings of U.S. Pat. No. 4,227,806 and U.S. Pat. No. 4,726,67 previously described. Moreover, the curve n(r) of each section is determined by measuring a first refractive index profile n′(r) of said section; measuring a second refractive index profile n″(r) of the same section after having rotated the core rod of 90° about its axis; averaging the two curves n′(r) and n″(r); and averaging, in the resulting curve, the two halves (left and right). The curves n_{I}(r) of the different sections are then stored in the processing unit 16.

Processing unit 16 then performs a simulation and further operations on these curves.

In a simulation (block 420), processing unit 16 determines how the refractive index profiles n_{I}(r) will be influenced by the stretching of the glass body in the drawing process, by the application of an overcladding mass in the overcladding deposition process and by variations in the drawing tension during the drawing process. In particular, a plurality n of different values OMⱼ (j=1, 2, . . . n) of the overcladding mass and a plurality p of different tension values Tₖ (k=0, 1, . . . p) are considered. The Applicant has verified that stretching the glass body and applying an overcladding mass produce a variation of the scale on the r axis in the n(r) diagram, while varying the drawing tension produces a variation of the scale on the n axis in the n(r) diagram. As a result, a matrix mxnxp of curves nᵢⱼₖ(r) is obtained, wherein each curve nᵢ(r) has given rise to nxp different curves with different r-scale and n-scale variation factors.

The processing unit 16 then solves (block 430), for each curve nᵢⱼₖ(r), the Maxwell propagation equations for an electromagnetic radiation in a fibre having such a refractive index profile and determines, by using for example the method proposed by Qing-Yu-Li in “Propagation characteristics of single-mode optical fibre with arbitrary refractive index profile: the finite quadratic element approach” J.Lightwave Technology 9 (1991) 22, the value of at least a predetermined optical propagation parameter P resulting from the propagation conditions established by solving the Maxwell equations. In the preferred case here considered, a plurality q of parameters P_{I} (I=0, 1, . . . q) is considered. Examples of possible parameters are the mode dispersion at 1530 nm, the mode dispersion at 1565 nm, the mode field diameter MFD at 1550 nm and the cut-off wavelength.

Then, processing unit 16 compares (block 440) the values of the considered parameters P_{I} with predetermined minimum and/or maximum values P_{I,min} and P_{I,max}. In particular, processing unit 16 considers a target function G, which measures the probability of realizing a fibre within the specifications, taking into account the standard deviation of the simulation error. Function G may be related to the different parameters P_{I} as follows:

$$G = {\prod }_{l} [ 1 - Q ( \frac{{P}_{l} - {P}_{l , min}}{{σ}_{l}} ) - Q ( \frac{{P}_{l , max} - {P}_{l}}{{σ}_{l}} ) ]$$

where Q(z) is a decreasing function which is 1 at z=0 and goes to zero for z which tends to infinity. If only one condition is imposed, which can be the condition on the maximum or that on the minimum, the part relating to the other condition (minimum or maximum) will be absent in the previous formula. Function G, which has a maximum value of 1, is computed for each different curve nᵢⱼₖ(r), thus obtaining a matrix of mxnxp values Gᵢⱼₖ.

According to the above representation, to each considered value of the overcladding mass OMⱼ there can be associated a corresponding two-dimensional discrete function Gᵢₖ of the drawing tension and of the normalized longitudinal coordinate z along the core rod. From this sampled function Gᵢₖ it is possible to derive (block 450), through a cubic polynomial interpolation (spline), a corresponding continuous function G(T,z). Thus, n different continuous functions Gⱼ(T,z) are found for the n different overcladding mass values OMⱼ.

For each of said Gⱼ(T,z) functions, it is possible to find (block 460), on the T-z plane, the path T(z) along which the G(T,z) function is maximised (i.e. optimized), i.e. along which

$$\frac{\partial G}{\partial T} {\vert}_{z} = 0$$

(or G=G(T₀,z), or G=G(Tₚ,z), when G, at a given position z, is maximum at one of the extremes (T₀, Tₚ) of the tension range considered). This path identifies the optimum T(z) function, to be used in the drawing process.

Finally, the optimum overcladding mass OM can be determined (block 470) among the n values OMⱼ previously considered, as that mass associated to the T(z) curve providing the highest values of G.

At the end of this processing stage, the processing unit 16 feeds to control unit 5 a signal containing the information about the optimum law T(z) and the optimum mass OM, to be used for controlling the overcladding deposition process and drawing process as previously described.

Just as an example of a practical case, a core rod 7 having a diameter of 1 cm and a length of 110 cm may be analysed by considering:
ten equally-spaced sections S₁, S₂, . . . S₁₀;
twenty values of the overcladding mass OM₁, OM₂, . . . OM₂₀ spaced of 100 g between 5200 g and 7100 g; and
seven values of the drawing tension T₁, T₂ . . . . T₇ spaced of 25 g between 200 and 350 g.

Therefore, at the end of the second simulation, a matrix of 10×20×7 curves nᵢⱼₖ(r) is obtained. After solving the Maxwell equation for each of said curves, the following parameters and the following conditions may for example be considered:
dispersion at 1530 nm (D1530)>2 ps/nm/Km;
dispersion at 1565 nm (D1565)<6 ps/nm/Km;
10.0 μm>MFD at 1550 nm>9.2 μm.

The following correlation parameter G is therefore computed:

$$\begin{matrix}G = [ 1 - Q ( \frac{{D}_{1530} - 2}{{σ}_{1530}} ) ] \cdot \\ [ 1 - Q ( \frac{6 - {D}_{1565}}{{σ}_{1565}} ) ] \cdot \\ [ 1 - Q ( \frac{MDF - 9.2}{{σ}_{MDF}} ) - Q ( \frac{10.0 - MDF}{{σ}_{MDF}} ) ]\end{matrix}$$

For each curve nᵢⱼₖ(r), a corresponding matrix of 10×20×7 values Gᵢⱼₖ is therefore obtained and the subsequent operations are performed as previously described.

The process according to the present invention may be also performed in an alternative way, in which the refractive index profiles are detected, instead of on the core rod 7, directly on the final preform 20 before the drawing process.

When it is used to host the final preform 20, chamber 6 of measuring device 2 is preferably filled with an index-matching liquid (for example an oil) having substantially the same refractive index of the cladding portion of the preform 20.

The process is therefore changed as shown in the flow-chart of FIG. 8, wherein the step of measuring the refractive index profile, here indicated with 400′, is shifted after the step of consolidating the final preform (block 600) and before the step of drawing the optical fibre (block 700).

In this alternative process, the overcladding process is obviously not influenced by the measurement of the refractive index profile (being performed before), and the results of said measurement are only used to intervene on the drawing process. The process of measuring the refractive index profile n(r) (block 400′) can in this case be performed as hereinbelow described with reference to FIG. 9.

In a first step (block 410′) the refraction index profile n(r) is measured on a plurality m of sections S₁ (i=1, 2, . . . m) of the final preform 20, in the same way as previously described for core rod 7, thus obtaining a plurality m of curves nᵢ(r). The curves nᵢ(r) of the different sections are stored in the processing unit 16.

Then, a simulation is performed (block 420′), wherein processing unit 16 determines how the refractive index profiles n(r) will be influenced by the stretching of the glass body in the drawing process and by variations in the drawing tension during the drawing process. In particular, a plurality p of different tension values Tₖ (k=0, 1, . . . p) are considered. As previously stated, stretching of the glass body will result in a variation of the scale on the r axis in the nᵢ(r) curves, while varying the drawing tension produces a variation of the scale on the n axis of these curves. As a result, a matrix mxp of curves nᵢₖ(r) is obtained, wherein each curve nᵢ(r) has given rise to p different curves with different n-scale variation factors.

Again, the processing unit 16 then solves (block 430′), for each curve nᵢₖ(r), the Maxwell propagation equations for an electromagnetic radiation in a fibre having such a refractive index profile and determines the value of predetermined optical propagation parameters P_{I}. Then, processing unit 16 determines (block 440′) a mxp matrix Gᵢₖ consisting of the values of the target function G related to the nᵢₖ(r) curves.

From the Gᵢₖ matrix, the processing unit 16 derives (block 450′), through a cubic polynomial interpolation (spline), a corresponding continuous function G(T,z), where z is the normalized longitudinal coordinate along the preform.

Processing unit 16 then determines (block 760′), in the T-x plane, the path T(z) along which the G(T,z) function is maximised, i.e. along which

$$\frac{\partial G}{\partial T} {\vert}_{z} = 0$$

(or G=G(T₀,z), or G=G(Tₚ,z), when G, at a given position z, is maximum at one of the extremes (T₀, Tₚ) of the tension range considered). This path identifies the optimum T(z) function, to be used in the drawing process.

The Applicant has performed simulations and experiments to verify the effectiveness of the method of the present invention. In particular, the effect of a drawing tension variation on the previously defined parameters D1530, D1565 and MFD have been verified.

FIGS. 10a, 10b and 10c refer to P_{I} parameters D1530, D1565 and MFD previously defined, respectively. The abscissa axis relates to the normalized length of the drawn fibre and the ordinate axis corresponds to the considered P_{I} parameter. In each figure, curve a is a simulation curve relating to a fibre drawn at a constant drawing tension of 300 g, curve b is a simulation curve relating to a fibre drawn for its first quarter at a tension of 250 g and for the remaining three quarters at a tension of 300 g, and curve c is a experimental curve relating to a fibre drawn in the same conditions of curve b. Dashed lines represent the maximum and/or minimum values (according to specifications) of the considered parameters.

It can be observed that, while a drawing performed at a constant tension leads to a high variation of the considered parameters along the fibre, with the risk of exceeding the specifications limits, an appropriate variation of the tension can reduce the range of variations of the parameters. In particular, it can be guaranteed that the parameters remain sufficiently far from the specifications limits.

The situation above depicted is a very simple one, which considers a single variation of the drawing tension during the process. In a real situation, the method of the present invention is conceived to vary the drawing tension a predetermined number of times during the drawing process, so as to reduce to a minimum the variations of the optical propagation parameters.

It will be apparent to those skilled in the art that various modifications and variations can be made to the disclosed embodiment of the present invention without departing from the scope or spirit of the invention.

For example, it will appear evident that the refractive index profile measurement can be performed on every type of preform suitable to be drawn into an optical fibre, in particular also on preforms produced by a VAD or a MCVD deposition process.

Moreover, it can be appreciated that, although a single control unit 5 has been illustrated and described for the sake of simplicity, deposition device 3 and drawing tower 4 can be controlled by different control units, which could receive from measuring device 2 respective information on how to perform the corresponding process steps in order to reduce the refractive index variations along the final fibre.

It can be further appreciated that, in its simplest conception, the process of the present invention comprises varying the drawing tension according to measured refractive index profiles (in the core rod or in the final preform) so as to produce a fibre having substantially uniform optical propagation parameters. Processing the measured refractive index profiles, for example as previously described, is an advantageous way of providing an optimum law of variation of the drawing tension to be applied during the drawing process

1. A method for determining a drawing tension variation law for an optical fibre drawing process, comprising the steps of:
measuring the refraction index profile in a plurality of sections of a glass preform suitable to be drawn into said optical fibre, for obtaining a corresponding plurality of refractive index profiles; and
processing said plurality of refractive index profiles for determining said drawing tension variation law.

2. A method for determining a drawing tension variation law for an optical fibre drawing process, comprising the steps of:
measuring the refraction index profile in a plurality of sections of a core rod suitable to be formed into a central portion of the optical fibre, for obtaining a corresponding plurality of refractive index profiles; and
processing said plurality of refractive index profiles for determining said drawing tension variation law.

3. The method of claim 1 or 2, wherein processing said plurality of refractive index profiles comprises simulating the effect of varying the drawing tension on each refractive index profile of said plurality of refractive index profiles.

4. The method of claim 1 or 2, wherein processing said plurality of refractive index profiles comprises determining a target function that correlates at least a predetermined optical propagation parameter with the drawing tension and with a normalized longitudinal coordinate along the glass preform or the core rod, respectively, and finding a path in the plane of the values of the drawing tension and of said normalized longitudinal coordinate that optimizes said target function.

5. A process for manufacturing an optical fibre, comprising the steps of:
producing a glass preform;
measuring the refraction index profile in a plurality of sections of the glass preform for obtaining a corresponding plurality of refractive index profiles;
processing said plurality of refractive index profiles for determining a drawing tension variation law; and
drawing said optical fibre from said glass preform by applying a drawing tension to said optical fibre, comprising varying said drawing tension in accordance with said drawing tension variation law.

6. A process for manufacturing an optical fibre, comprising the steps of:
producing a glass core rod;
measuring the refraction index profile in a plurality of sections of the core rod, for obtaining a corresponding plurality of refractive index profiles;
processing said plurality of refractive index profiles for determining a drawing tension variation law;
depositing glass soot onto said core rod to obtain a glass preform;
consolidating said glass preform; and
drawing said optical fibre from said glass preform by applying a drawing tension to said optical fibre, comprising varying said drawing tension in accordance with said drawing tension variation law.

7. The process of claim 5 or 6, wherein processing said plurality of refractive index profiles comprises simulating the effect of varying the drawing tension on each refractive index profile of said plurality of refractive index profiles.

8. The process of claim 5 or 6, wherein processing said plurality of refractive index profiles comprises determining a target function that correlates at least a predetermined optical propagation parameter with the drawing tension and with a normalized longitudinal coordinate along the glass preform or the core rod, respectively, and finding a path in the plane of the values of the drawing tension and of said normalized longitudinal coordinate that optimizes said target function.

9. The process of claim 6, wherein processing said plurality of refractive index profiles comprises determining the amount of said glass soot to be deposited onto said cylindrical glass body.

10. The process of claim 9, wherein determining the amount of said glass soot to be deposited comprises simulating, for each of said sections, the effect of varying the amount of said deposited glass soot on each refractive index profile of said plurality of refractive index profiles.

11. The process of claim 5 or 6, wherein varying said drawing tension comprises varying the speed at which the fibre is drawn.

12. The process of claim 5 or 6, wherein drawing said optical fibre comprises subjecting said glass preform to a glass melting temperature and wherein varying said drawing tension comprises varying said glass melting temperature.

13-19. (canceled)

20. A device for determining a drawing tension variation law for an optical fibre drawing process, comprising a device for measuring the refractive index profile along a cylindrical glass body suitable to be formed into at least a central portion of the optical fibre and a processing unit for processing the results of said measurement to obtain said draw tension variation law.

21. The device of claim 20, wherein the processing unit comprises means for simulating the effect of varying the draw tension on the measured refractive index profile.

22. An assembly for manufacturing an optical fibre comprising:
an apparatus for producing a cylindrical glass body suitable to be formed into at least a central portion of the optical fibre;
a device for determining a drawing tension variation law for an optical fibre drawing process, comprising a device for measuring the refractive index profile along a cylindrical glass body suitable to be formed into at least a central portion of the optical fibre and a processing unit for processing the results of said measurement to obtain said draw tension variation law; and
a drawing apparatus for drawing said optical fibre including draw tension regulating means to regulate the draw tension according to the draw tension variation law.

23. The device of claim 22, wherein the processing unit comprises means for simulating the effect of varying the draw tension on the measured refractive index profile.

24. The assembly of claim 22, further comprising a deposition device for depositing glass soot onto said cylindrical glass body so as to obtain a glass preform and a consolidation device for consolidating said glass preform.

25. The assembly of claim 23, wherein the draw tension regulating means comprise a glass melting furnace and a control unit for feeding to said furnace a control signal in accordance with said draw tension variation law.

26. The assembly of claim 23, wherein the draw tension regulating means comprises a traction device for pulling the optical fibre from the glass preform and a control unit for feeding to said traction device a control signal in accordance with said draw tension variation law.

27. The assembly of claim 23, wherein the processing unit comprises means for simulating the effect of varying the amount of the deposited glass soot on the measured refractive index profile.
